(19) United States
(12) Patent Application Publication
(10) Pub. No.: US 2012/0234988 A1
(43) Pub. Date: Sep. 20, 2012

(54) STRUCTURE FOR MOUNTING CABLES TO A DEVICE

(75) Inventor: Hsin Lang CHENG, Shijr city (TW)

(73) Assignee: ATEN INTERNATIONAL CO., LTD., Taipei (TW)

(21) Appl. No.: 13/314,087

(22) Filed: Dec. 7, 2011

(30) Foreign Application Priority Data
Mar. 15, 2011 (TW) 100108834

(51) Int. Cl. F16L 3/08; F16M 13/02

(52) U.S. Cl. 248/73; 248/224.8

(57) ABSTRACT

A fixing structure for fixing a device onto a casing. The casing includes a first side, a second side and a first hole. The first side is opposite to the second side. The first hole penetrates the first side and the second side. The device is inserted on the first side of the casing. The fixing structure includes a looping portion, a first string and at least one first protrusion. The looping portion is located at the first side of the casing and has an opening. The device is fastened in the opening. The first string is connected to the looping portion. The first protrusion is fixed to and protrudes from the first string. The first string passes through the first hole from the first side of the casing, so that the first protrusion presses on the second side of the casing.

### BACKGROUND OF THE INVENTION

1. Field of the Invention

This invention relates to a fixing structure and a fixing assembly for using the fixing structure, and in particular, it relates to a fixing structure and a fixing assembly for using the fixing structure to fix a device onto a casing.

2. Description of the Related Art

When a conventional plug such as a power cable plug is plugged to a product such as an electronic product, the plug often gets loose or detached from the product because the coupling between the product and the plug is not very strong or the plug is inadvertently pulled by the user of the product, which interrupts the normal operation of the product such that it cannot function normally. To avoid this problem, some of the plugs sold on the market come with coupling structures to better secure the coupling between the product and the plug. However, the coupling structures are often designed to match the sizes and shapes of specific plugs, so one coupling structure is often suitable for use with only one specific type of plugs. This limits the range of usefulness of the coupling structures. In addition, conventional coupling structure often includes multiple parts, which increases the labor and time needed for assemble and set up the coupling structure, resulting in increased production costs. Therefore, it has been a topic of interest and focus in the related industry to provide a structure to securely fixing a plug onto a product and also reduce the production cost of the fixing structure.

### SUMMARY OF THE INVENTION

The following summary extracts and compiles some of the features of the present invention, while other features will be disclosed in the follow-up detailed descriptions of the invention. It is intended to cover various modifications and similar arrangements included within the spirit and scope of the appended claims.

It is one of the objects of the present invention to provide a fixing structure and a fixing assembly for using the fixing structure, including a looping portion fastening a device on a first side of a casing, and connecting a protrusion which presses on a second side of the casing, so that the device can be securely inserted into the first side of the casing.

According to the exemplary embodiments of the present invention, there is provided a fixing structure for fixing a device to a casing. The casing has a first side, a second side and a first hole. The first side is opposite to the second side. The hole penetrates through the casing from the first side to the second side. The device is inserted into the first side of the casing. The fixing structure includes a looping portion, a first string and at least a first protrusion. The looping portion is located at the first side of the casing and has an opening. The device is coupled in the opening. The first string is connected to the looping portion. The at least one first protrusion is fixed on and protruding from the first string. The first string passes through the hole from the first side of the casing such that the at least one first protrusion presses on the second side of the casing.

The exemplary embodiments of the present invention also provide a fixing assembly that includes a casing and a fixing structure. The casing has a first side, a second side and a first hole. The first side is opposite to the second side. The hole penetrates through the casing from the first side to the second side. A device is inserted into the first side of the casing. The fixing assembly includes a looping portion, a first string and at least a first protrusion. The looping portion is located at the first side of the casing and has an opening. The device is coupled in the opening. The first string is connected to the looping portion. The at least one first protrusion is fixed on and protruding from the first string. The first string passes through the hole from the first side of the casing such that the at least one first protrusion presses on the second side of the casing.

In one embodiment of the present invention there is provided a fixing structure for fixing a device onto a casing. The casing includes a first side, a second side and a first hole. The first side is opposite to the second side. The first hole penetrates the first side and the second side. The device is inserted on the first side of the casing. The fixing structure includes a looping portion, a first string and at least one first protrusion. The looping portion is located at the first side of the casing and has an opening. The device is fastened in the opening. The first string is connected to the looping portion. The first protrusion is fixed to and protrudes from the first string. The first string passes through the first hole from the first side of the casing, so that the first protrusion presses on the second side of the casing.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

FIG. 1A is a prospective view diagram illustrating a device fixed by a fixing assembly in accordance with an embodiment of the present invention.

FIG. 1B is a top view diagram illustrating the device fixed by the fixing assembly in accordance with the embodiment of the present invention shown in FIG. 1A.

FIG. 1C is a diagram illustrating a fixing structure in accordance with the embodiment of the present invention shown in FIG. 1A.

FIG. 2 is a diagram illustrating the first hole in accordance with the embodiment of the present invention shown in FIGS. 1A and 1B.

FIGS. 3A˜3C are diagrams illustrating attaching the first string of the fixing structure to the first hole in accordance with the embodiment of the present invention.

FIG. 4 is a diagram illustrating a fixing assembly in accordance with another embodiment of the present invention.

FIG. 5 is a diagram illustrating a fixing assembly in accordance with still another embodiment of the present invention.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structure and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as other alternative embodiments) of the present invention.

One preferred embodiment of the present invention provides a fixing structure and a fixing assembly for using the fixing structure. The fixing structure includes a looping portion, a first string and at least one first protrusion. The looping portion is located at a first side of a casing and has an opening. The first string is connected to the looping portion. The first protrusion is fixed to and protruding from the first string. Below is a further description.

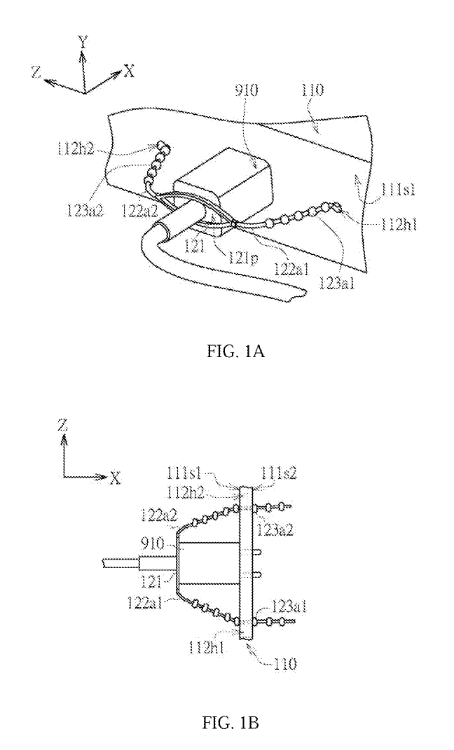

Referring to FIGS. 1A, 1B and 1C, FIG. 1A is a prospective view diagram illustrating a device fixed by a fixing assembly in accordance with an embodiment of the present invention, FIG. 1B illustrates a top view of the device fixed by the fixing assembly shown in FIG. 1A, and FIG. 1C illustrates the fixing structure shown in FIG. 1A.

Fixing assembly includes casing 110 and fixing structure 12. Casing 110 includes a first side 111s1, a second side 111s2, a first hole 112h1 and a second hole 112h2. The first side 111s1 is opposite to the second side 111s2. The first hole 112h1 and the second hole 112h2 penetrate through the first side 111s1 and second side 111s2.

In this embodiment, fixing structure 12 (as shown in FIG. 1C) includes a looping portion 121, a first string 122a1, a second string 122a2, a plurality of first protrusions 123a1 and a plurality of second protrusions 123a2.

The assembling relationship of the various parts of the fixing structure 12 will be described first. Looping portion 121 has an opening 121p. The first string 122a1 and second string 122a2 are connected to the looping portion 121. The plurality of first protrusions 123a1 are fixed on and protruding from the first string 122a1, and the plurality of second protrusions 123a2 are fixed on and protruding from the second string 122a2.

In this embodiment, the device 910 may be for example a plug inserted on the first side 111s1 of the casing 110. This embodiment provides a fixing mechanism by the fixing structure 12 so that the device 910 can be securely inserted to the first side 111s1 of the casing 110. The looping portion 121 is located at the first side 111s1 of the casing 110, and the device 910 is coupled in the opening 121p of the looping portion 121. The first string 122a1 that connects the looping portion 121 passes through the first hole 112h1 from the first side 111s1 of the casing 110, so that one of the plurality of first protrusions 123a1 presses on the second side 111s2 of the casing 110. In addition, the second string 122a2 that also connects the looping portion 121 passes through the second hole 112h1 from the first side 111s1 of the casing 110, so that one of the plurality of second protrusions 123a2 presses on the second side 111s2 of the casing 110. Hence the device 910 can be secured by the fixing structure 12 to be securely plugged to the first side 111s1 of the casing 110, to avoid the situation where device 910 is falling off as a result of an external pulling force or a weak coupling force.

Since in the embodiment it is the looping portion 121 which is coupled to the device 910, the coupling and fixing between any shaped device and the casing can be realized by the fixing structure of the embodiment of the present invention. In other words, the fixing structure 12 has a wide range of application. In addition, in terms of the material of the fixing structure 12, in this embodiment the fixing structure 12 may be made of a plastic material through an injection molding process. For example, the plastic material may be Polyethylene (PE) or Nylon 66. This way, comparing to conventional fixing structures that consist multiple inter-assembled parts and components, the fixing structure 12 of this embodiment is not only simple in its manufacturing process, and low cost to produce, but also small in size.

To provide a better fixing result, in this embodiment the location where the first string 122a1 is connected to the looping portion 121 is located opposite to the location where the second string 122a2 is connected to the looping portion 121, and the fixture structure is placed over the device 910 such that its looping portion fastens on at least part of the device 910, so that it presses on device 910 while fixing.

In addition, for example, in this embodiment, the first hole 112h1 and the second hole 112h2 are located symmetrically to the Y-axis; the first hole 112h1 and the second hole 112h2 have a shape and a similar dimension; and the first protrusions 123a1 and the second protrusions 123a2 have similar shape and size. Therefore, in the description below only the first hole 112h1 and first protrusions 123a1 will be described in detail.

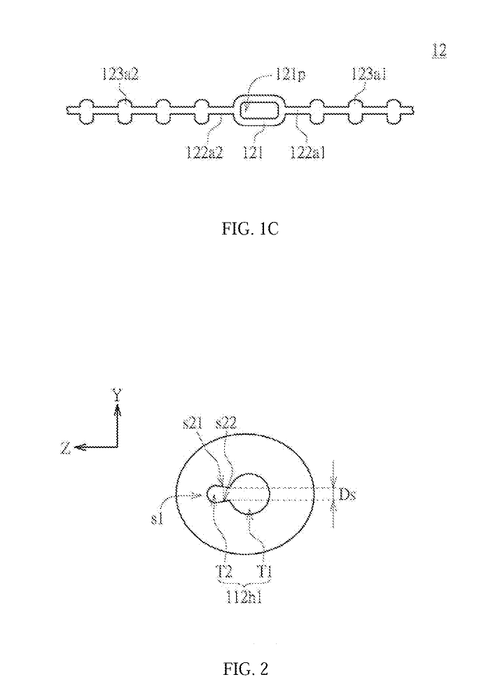

Referring to FIG. 2, there is shown the first hole of FIGS. 1A and 1B. The first hole 112h1 has a first notch T1 and a second notch T2. The second notch T2 is connected to the first notch T1. The size of the first notch T1 is large than that of the second notch T2. The first notch T1 is used to allow the first protrusions 123a1 and the first string 122a1 to pass, whereas the second notch T2 is used to allow only the first string 122a1 to pass.

Moreover, any one of the first protrusions 123a1 has a length in at least one dimension larger than the length of the second notch T2 in the same dimension, to serve as a mechanism for preventing the first protrusions 123a1 to pass through the second notch T2. In the examples of this embodiment the first protrusion 123a1 has a length in any dimension is larger than the length of the second notch T2 any dimension.

Additionally, the inner sidewall of the second notch T2 has a first inner sidewall s2 and two second inner sidewalls s21 and s22. The two second inner sidewalls s21 and s22 respectively connect to the two opposite edges of the first inner sidewall s1, and the distance between the two second inner sidewalls s21 and s22 is gradually reduced towards the direction of the first notch T1, such that the distance between the two second inner sidewalls s21 and s22 is smallest at the location where it is the closest to the first notch T1. Here the distance between the two second inner sidewalls s21 and s22 at the location where it is the closest to the first notch T1 is deemed the smallest distance Ds at where the first notch T1 and the second notch T2 connect. In order to prevent the first string 122a1 from slipping out of the second notch T2 after it is placed in the second notch T2, in this embodiment the smallest distance Ds at where the first notch T1 and the second notch T2 connect is less or equal to the outer diameter of the first string 122a1.

Since in this embodiment the first hole 112h1 and the second hole 112h2 have similar shape and size, and the first protrusions 123a1 and the second protrusions 123a2 have similar shape and size, the second hole 112h2 has a similar first and second notches to correspond with the second protrusions 123a2, except the direction from the first notch T1 and second notch T2 of the first hole 112h1 is parallel but opposite to except the direction from the first and second notches of the second hole.

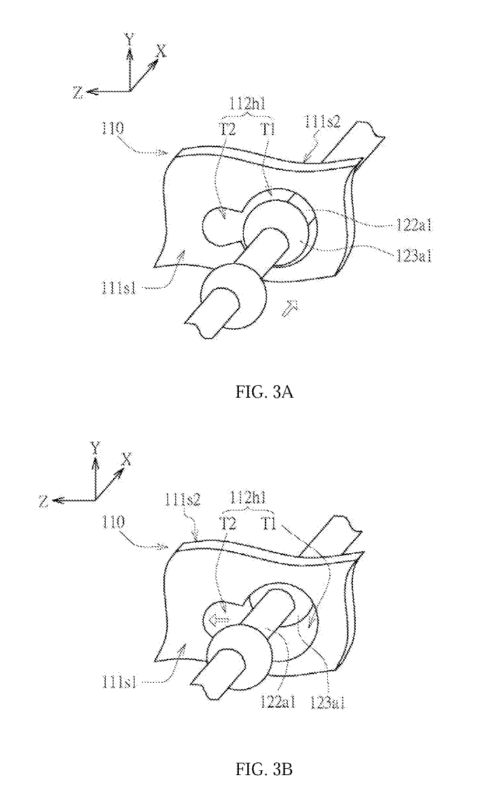

Please refer to FIGS. 1A, 1B, 3A-3C. FIGS. 3A-3C illustrate attaching the first string of the fixing structure to the first hole.

As shown in FIG. 3A, a user may move excessive portions of the first string 122a1 and the multiple first protrusions 123a1 thereon from the first side 111s1 to the second side 111s2 of the casing 110 along the +X-axis direction through the first notch T1 to adjust the length of the portion of the first string 111s1 that is left in the first side 111s1 of the casing 110.

As shown in FIG. 3B, once the length of the portion of the first string 122a1 remaining on the first side 111s1 of the casing is determined, the user may push the first string 122a1 towards the second notch T2 of the first hole 122h1 along the +Z-axis direction, so that the first string 122a1 passes through where the first notch T1 and second notch T2 connect.

As shown in FIG. 3C, since the smallest distance Ds at where the first notch T1 and the second notch T2 connect is less or equal to the outer diameter of the first string 122a1, the first string 122a1 may not easily slip out of the second notch T2 after it is placed therein, so that the attachment is secured.

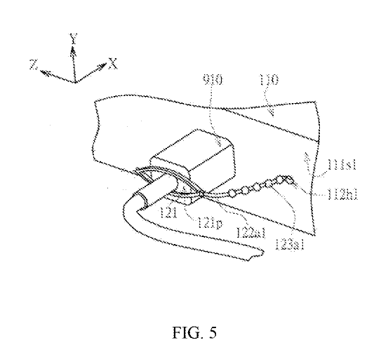

The corresponding attachment between the second protrusions 123a1 and the second hole 112h2 is achieved in the same manner as described above. Therefore, the device 910 can be securely fixed to the casing 110 by the fixing structure 12, as shown in FIGS. 1A and 1B. The device 910 can also be fixed to the casing 110 by using only the first string 122a1 and the first protrusions 123a1 (of the fixing structure 12) which is to be retained by the second notch T2 of the first hole 112h1, as shown in FIG. 5.

When the user wants to remove device 910, the user may move the first string 122a1 along the -Z-axis direction back to the first notch T1 through where the first notch T1 and second notch T2 connect, so that the portion of the first string 122a1 in the second side 111s2 and the multiple protrusions 123a1 thereon may returned back to the first side 111s1 of the casing 110. Similarly, the portion of the second string 122a2 in the second side 111s2 and the multiple protrusions 123a2 thereon may return back to the first side 111s1 of the casing 110. As a result, the fixing structure can be separated from the casing 110 so the user can remove device 910 from the casing 110.

While in this embodiment the device is described as a plug as an example, a person of ordinary skill in the art can understand that device 910 may also be a connector or a protruding portion of an electrical wire. In addition, the shape and side of the first protrusions may be adjusted according to needs. Any shape or size that allows the first protrusion to pass the first notch but not the second notch may be adopted. The corresponding relationship between the second protrusions and the second hole and their design can follow the corresponding relationship between the first protrusions and the first hole and their design.

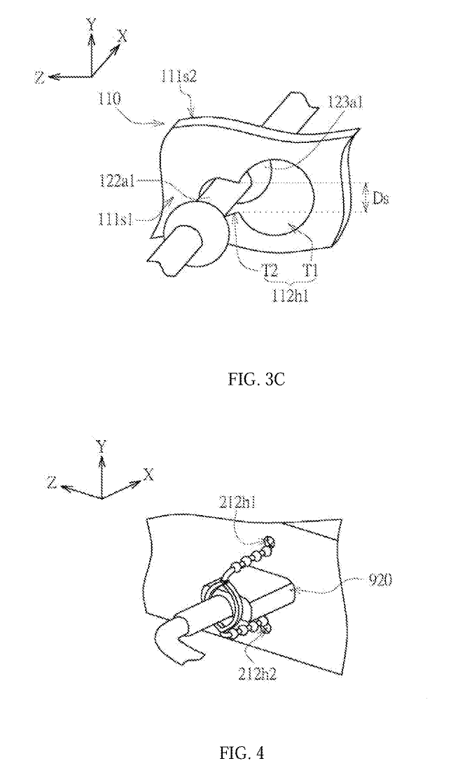

In the above description, the first hole 112h1 and the second hole 112h2 are symmetrical about the Y-axis. Referring to FIG. 4, there is illustrated another embodiment of the present invention fixing assembly. A first hole 212h1 and a second hole 212h2 are symmetrical about the Z-axis, and the first fixing structure 12 is at least placed cross-over a part of a device 920 and its looping portion 121 coupled with the part of device 920 to provide a secured fixing result.

In other embodiments the first and second holes may also be symmetrical about other directions. Furthermore, the first and second holes do not have to be symmetrical. Their location may be anywhere as long as a part of the fixing structure, which structure passes the first and second hole, crosses over a part of the device to provide a fixing pressure.

In addition, referring to FIGS. 1A and 4, the direction from the first notch of the first hole to the second notch of the first hole is opposite to the direction from the first notch of the second hole to the second notch of the second hole. However a person of ordinary skill in the art understands that the direction from the first notch of the first hole to the second notch of the first hole is not necessarily opposite to or parallel to the direction from the first notch of the second hole to the second notch of the second hole. Any suitable arrangement of the notches of the first and second holes may be adopted as long as the fixing structure that passes through the first and second holes can achieve a fixing result.

The fixing structure and the fixing assembly that uses the fixing structure in accordance with the embodiments of the present invention provides a method that coupling a device on a first side of a casing in an opening of a looping portion and pressing the protrusions that are connected to the looping portion against the second side of the casing, so that the device can be securely plugged into the first side of the casing. Therefore using the fixing structure can prevent the device from detaching from the casing due to the lack of coupling force or due to an external force, while allowing the user easily assembly or dissemble the fixing structure. In addition, since the fixing structure can be used to fix a device of any shape to a casing, the fixing structure has a very wide application. In one embodiment, the fixing structure may be made of plastic material through an injection molding process which has the advantages of simple process and low cost production.

Although examples of the preferred embodiments of the present invention system and method are shown and described in detail above, the present invention is not limited to the specifics described herein. It will be apparent to those skilled in the art that various modification and variations can be made in the system and method of the present invention without departing from the spirit or scope of the invention. Thus, it is intended that the present invention cover modifications and variations that come within the scope of the appended claims and their equivalents.

What is claimed is:

1. A fixing structure for fixing a device to a casing, wherein the casing has a first side, a second side and a first hole, the first side is opposite to the second side, the hole penetrates through the first side and second side, the device is plugged into the first side of the casing, the fixing structure comprising:
a looping portion, located on the first side of the casing, and having an opening for coupling the device;
a first string, connected to the looping portion; and
at least one first protrusion fixed on and protruding from the first string, wherein the first string passes through the first hole from the first side of the casing, such that the at least one first protrusion presses on the second side of the casing.

2. The fixing structure of claim 1, wherein the casing has a second hole penetrating through the first side and second side, the fixing structure further comprising:
a second string, connected to the looping portion; and
at least one second protrusion fixed on and protruding from the second string, wherein the second string passes through the second hole from the first side of the casing, such that the at least one second protrusion presses on the second side of the casing.

3. The fixing structure of claim 2, wherein the first string is connected to the looping portion at a location opposite to another location where the second string is connected to the looping portion.

4. The fixing structure of claim 2, wherein at least a portion of the fixing structure crosses over at least a portion of the device.

5. The fixing structure of claim 1, wherein the device is a plug, a connector or a protruding portion of a cable.

6. A fixing assembly, comprising:
a casing having a first side, a second side and a first hole, wherein the first side is opposite to the second side, the hole penetrates through the first side and second side,
a device plugged into the first side of the casing, and
a fixing structure, comprising:
a looping portion, located on the first side of the casing, and having an opening for coupling the device;
a first string, connected to the looping portion; and
at least one first protrusion fixed on and protruding from the first string, wherein the first string passes through the first hole from the first side of the casing, such that the at least one first protrusion presses on the second side of the casing.

7. The fixing assembly of claim 6, wherein the casing has a second hole penetrating through the first side and second side, the fixing structure further comprising:
a second string, connected to the looping portion; and
at least one second protrusion fixed on and protruding from the second string, wherein the second string passes through the second hole from the first side of the casing, such that the at least one second protrusion presses on the second side of the casing.

8. The fixing assembly of claim 7, wherein the first string is connected to the looping portion at a location opposite to another location where the second string is connected to the looping portion.

9. The fixing structure of claim 7, wherein at least a portion of the fixing structure crosses over at least a portion of the device.

10. The fixing structure of claim 6, wherein the device is a plug, a connector or a protruding portion of a cable.

11. The fixing assembly of claim 6, wherein the first hole has a first notch and a second notch, the second notch is connected to the first notch, the size of the first notch is larger than the size of the second notch, whereas the first notch is for passing the at least one first protrusion and the first string, and the second notch is for passing the first string only.

12. The fixing assembly of claim 11, wherein the at least one first protrusion has a length in at least one direction larger than a length of the second notch in the at least one direction.

13. The fixing assembly of claim 11, wherein a minimum distance at where the first notch and the second notch connect is smaller or equal to an outer diameter of the first string.

14. The fixing assembly of claim 11, wherein the second notch has an inner sidewall including a first inner side wall and two second inner sidewalls, the two second inner sidewalls are connected to two opposite edges of the first inner sidewall respectively, and a distance between the two second inner sidewalls is gradually reduced towards a direction of the first notch.
